(19) United States
(12) Patent Application Publication
(10) Pub. No.: US 2014/0297817 A1
(43) Pub. Date: Oct. 2, 2014

(54) Managing Software Operations Based Upon User Status In A Unified Communications Environment

(71) Applicant: CISCO TECHNOLOGY, INC., San Jose, CA (US)

(72) Inventors: Sreejith Nayappakkil Thikkalveettil, Bangalore (IN); Debanjan Biswas, Bangalore (IN); Vijayendra Shetty, Bangalore (IN); Soumendu Satapathy, Bangalore (IN)

(73) Assignee: Cisco Technology, Inc., San Jose, CA (US)

(21) Appl. No.: 13/850,559

(22) Filed: Mar. 26, 2013

(51) Int. Cl. H04L 12/24

(52) U.S. Cl. CPC H04L 41/0803
USPC 709/220

(57) ABSTRACT

Operation of a computing device is facilitated within a unified communications platform, where a user status designation is assigned to the computing device. A user configuration table for the computing device is established, where the user configuration table provides information relating to a plurality of user status designations associated with operation of the computing device within the unified communications platform. In response to identifying an automated software operation scheduled to be performed in association with the computing device, the user configuration table is consulted to determine a rule associated with the user status designation and the automated software operation. In response to a determination of the rule, the rule is applied that controls performance of the automated software operation at the computing device.

### TECHNICAL FIELD

The present disclosure relates to enhancing and controlling operations on a user's computer by controlling when certain software operations may be performed.

### BACKGROUND

When engaging in a communication, such as an audio and/or video conference session or an instant message session, or engaging in some other important task within a unified communications environment, certain software operations that operate automatically on a user's computer can disrupt operation of the communication or task in which the user is currently engaged. For example, while a user is engaged in a web conference session on the user's computer, the user might receive one or more instant messages that are disruptive to the web conference session (e.g., the user may be currently presenting content within the web conference session). In another example embodiment, the user may be engaging in a task, and the operating system or platform in which the user is operating may automatically initiate a software operation such as a data backup, a virus scan, etc., which consumes processor capacity and can slowdown or disrupt performance of the task by the user.

### BRIEF DESCRIPTION OF THE DRAWINGS

FIG. 1 is a schematic block diagram of an example unified communications system in which a user connects via a computing device with a unified client server to facilitate the computing device engaging in communications and exchange of content with other computing devices also connected with the unified client server.

FIG. 2 is a schematic block diagram of an example embodiment of a unified communications software application module associated with the computing device of the system of FIG. 1.

FIG. 3 is a schematic block diagram of an example embodiment of a unified communications software application module associated with a server of the system of FIG. 1.

FIG. 4 depicts an example embodiment of a configuration table associated with the computing device for the system of FIG. 1.

FIG. 5 is a flow chart depicting an example process for managing software operations on a user's computing device in the system of FIG. 1 utilizing the techniques described herein.

FIG. 6 depicts an example embodiment of a computing device engaging in a conference session with other computing devices via a unified communications platform and including scenarios in which other types of automated software operations that are scheduled to be performed at the computing device are prevented or delayed utilizing the techniques described herein.

### DESCRIPTION OF EXAMPLE EMBODIMENTS

### Overview

Operation of a computing device is facilitated, via a server within a unified communications platform, where a user status designation is assigned to the computing device. A user configuration table for the computing device is established, where the user configuration table provides information relating to a plurality of user status designations associated with operation of the computing device within the unified communications platform. In response to identifying, by at least one of the computing device and the server, an automated software operation scheduled to be performed in association with the computing device, the user configuration table is consulted to determine a rule associated with the user status designation and the automated software operation. In response to a determination of the rule, the rule is applied by at least one of the computing device and the server that controls performance of the automated software operation at the computing device.

### EXAMPLE EMBODIMENTS

Unified communications environments provide real-time communications between computing devices of different users at different endpoints via a suitable network platform capable of hosting such environments. A unified communications (UC) environment can facilitate a wide variety of activities and exchanges of communications and content for endpoint computing devices within the UC platform, where the UC platform provides software tools or software application modules and related services that link computing devices at different endpoints so as to allow users to communicate with each other in a variety of different ways. Such UC platforms can further allow users at different endpoint computing devices to share content (e.g., documents, graphics and/or or any other types of content or forms of information) via the platform.

The term “tool” is used herein to refer to one or more “application” software functions or sets of functions provided by one or more software applications on a computing device and/or hosted on a server on behalf of a computing device. Application modules refer to a set of one or more software applications that provide the software tools used by the computing devices and/or servers. The UC platform comprises software applications that perform the various operations and functions occurring within the platform which are located on endpoint computing devices of the users, one or more servers, as well as any other computing devices within the network.

The UC platform can utilize one or more servers that facilitate exchange of various types of communications and/or content between two or more computing devices as well as provide presence information for users at such computing devices and operating within the platform in real-time or near real-time (e.g., utilizing XMPP or any other suitable communications protocol). Some non-limiting examples of real-time or near real-time communications that can occur between user computing devices within a UC platform include email, instant messaging or short messaging service (SMS), audio and/or video (A/V) conferencing (including the sharing of content, such as desktop sharing by one or more users within the conference, white boarding, etc.), voice over IP phone (VoIP) services, etc. In addition, the UC platform can also support the exchange of content (e.g., blogs, documents or any other form of information or content) between user computing devices over the platform.

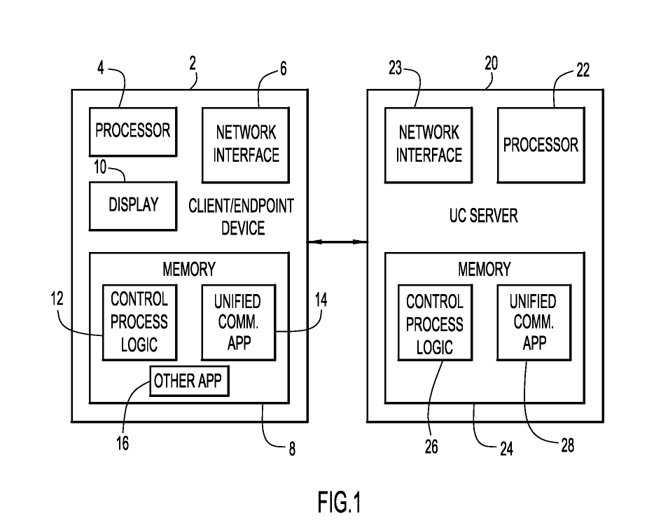

An example embodiment of a user computing device connected with a UC server to facilitate communication and/or exchange of content between the user computing device and other user computing devices within a UC platform is depicted in the block diagram of FIG. 1. The computing device can be any suitable type of computing device including, without limitation, a stationary (e.g., desktop) computer, a personal mobile computer device such as a laptop, a note pad, a tablet, a personal data assistant (PDA) device, any other suitable type of portable media player device, and a cell phone (e.g., a smartphone). The computing and server devices can utilize any suitable operating systems (e.g., Android, Windows, Mac OS, Symbian OS, RIM Blackberry OS, Linux, etc.) to facilitate operation, use and interaction of the devices with each other over one or more networks.

Referring to FIG. 1, a user's client endpoint computing device 2 connects with a UC server device 20 to facilitate real-time or near real-time communications and exchange of information with other computing devices associated with other users within the UC platform. While FIG. 1 depicts the single computing device 2 connected with the UC server device 20, it is noted that other computing devices within the platform connect with the server device 20 or any other suitable UC server device in the same or substantially similar manner within the platform. For example, the UC platform can include two computing devices or any suitable number of computing devices (e.g., ten, hundreds, thousands or more) having a similar configuration as computing device 2 and operating at any given time and utilizing any suitable number of UC servers having a similar configuration as UC server device 20. The computing devices and UC servers communicate and exchange communications and other content or information with each other over one or more networks. Examples of suitable types of networks that can be utilized to support the UC platform include, without limitation, any one or more of local or wide area networks, Internet Protocol (IP) networks such as intranet or internet networks, telephone networks (e.g., public switched telephone networks), wireless or mobile phone or cellular networks, and any suitable combinations thereof.

The computing device 2 connects via any suitable wireless and/or hard wired connection to the server device 20 to facilitate communications and exchange of information with other computing devices over the network. The computing device 2 includes a processor 4, a network interface 6, a memory 8, and a display 10. Similarly, the server device 20 includes a processor 22, a network interface 23, and memory 24. Each of the computing device 2 and the UC server device 20 can further include any other suitable devices integrated with the devices and/or any other types of peripheral devices that can be connected with the devices to facilitate input of audio, video or other information by a user to the computing device (e.g., keyboards, mouse devices, cameras, microphones, etc.) as well as output or display of audio, video and/or other types of information by the devices.

The network interfaces 6 and 23 of the computing device 2 and the UC server device 20 can be, for example, one or more of an Ethernet interface card or switch, a modem, a router or any other suitable hardware device that facilitates a wireless and/or hardwire connection over one or more networks with other computing devices and/or other server devices. The network interface unit for each device can be integrated within the device or a peripheral that connects with the device.

Each of the processors 4, 22 can comprise at least one microprocessor that executes control process logic instructions 12, 26 stored within memory 8, 24, including operational instructions associated with the operating system of each device and/or other software applications stored within such memory (e.g., applications associated with different types of communications and sharing of information via the UC platform).

The memories 8, 24 may comprise read only memory (ROM), random access memory (RAM), magnetic disk storage media devices, optical storage media devices, flash memory devices, electrical, optical, or other physical/tangible memory storage devices, and any combinations thereof.

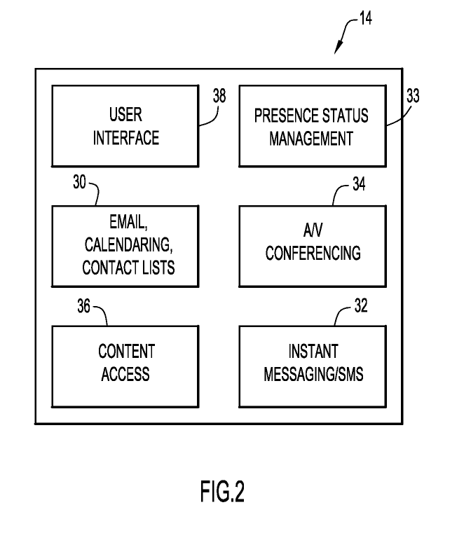

For example, the memory 8 of the computing device 2 includes a UC software application module 14 that comprises one or more software applications that provide software tools to facilitate connection of the computing device 2 with other computing devices, server device 20 and/or other server devices within the UC platform and also engage in various communications or other tasks or activities associated with the platform. An example embodiment of a UC application module 14 for the computing device 2 is depicted in FIG. 2. The UC software application module 14 includes software applications that facilitate various types of communications between the computing device 2 and other computing devices via the UC platform, including real-time or near real-time communications such as email messaging application(s) 30 (including, e.g., emailing, calendaring and scheduling, contact lists, etc.), instant messaging or SMS application(s) 32, and conferencing application(s) 34 that facilitate audio and/or video conferences between the computing device and other computing devices within the platform (including sharing of content, such as desktop sharing, from the computing device 2 with one or more computing devices within the A/V conference session). The module 14 also can include one or more content access applications 36 that facilitate posting of content, editing of content, viewing of content, etc. over the platform (e.g., documents, blogs and/or any other types of content or information posted by the user of the computing device 2 or by other users over the platform). The module 14 further includes one or more software applications 38 that provide a user profile interface displayed by the display 10 of the computing device 2, where the user profile interface facilitates navigation and interaction by the user in communications and exchange of information with other users as well as access to the various types of content provided within the UC platform. The user profile interface can also be used to allow the user to input and edit or modify information relating to the user's profile within the platform, including information in a configuration table associated with the user as described herein. One or more presence status management applications 33 are also provided in the module 14 of the computing device 2 to monitor, adjust and/or control the status of the computing device 2 locally, including monitoring of software operations in which the computing device is currently engaged (e.g., whether the computing device is currently engaged in a meeting conference session or other communication via the UC platform or engaged in any other local software operation). For example, the presence status management application(s) can adjust the user presence status automatically based upon operations occurring at the computing device 2 or can facilitate a manual change in user status by the user of the computing device 2.

The memory 8 of the computing device 2 further includes one or more other application modules 16, each of which includes one or more suitable software applications that perform a number of different software operations on the computing device 2, including software operations that are manually initiated and controlled by the user (e.g., opening of software programs, such as a word processing program or a spreadsheet program, to create/modify/edit/delete documents, opening of web browsers to facilitate navigation over one or more networks, etc.) as well as automatic or automated software operations that are not manually initiated by the user but instead automatically initiated based upon a predetermined condition associated with the computing device (e.g., activation of an antivirus scan of the computing device by one or more antivirus protection software applications, which may be initiated over select time periods and/or based upon one or more usage conditions of the computing device, activation of a disk scan or backup of data associated with the computing device, etc.) or based upon conditions not controlled by the user while the user is operating within an environment such as the UC platform (e.g., another user attempts to initiate a communication with the user of the computing device over the UC platform, such as via an instant message, an IP phone call or other type of real-time communication, or a system administrator initiates a software operation on the computing device, such as a software update).

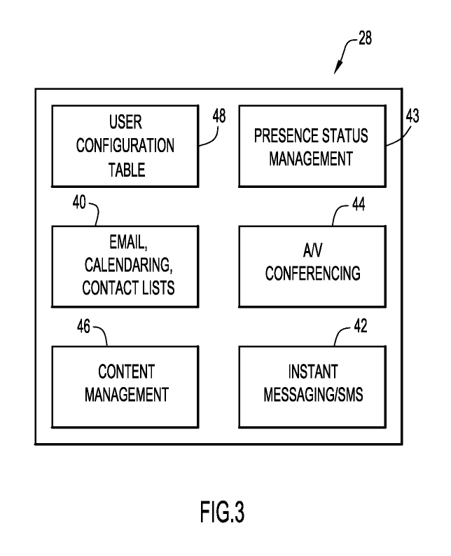

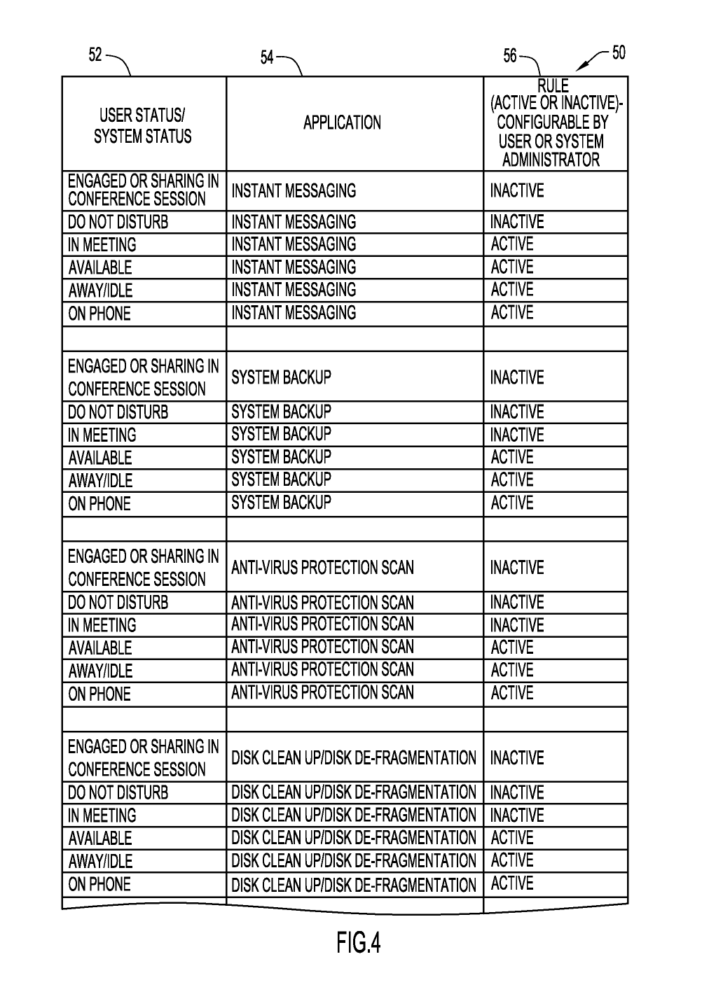

The memory 24 of the server device 20 also includes a UC application module 28 that comprises one or more software applications that provide software tools to facilitate hosting by the server of the various types of communications, sharing of content as well as other activities and tasks associated with the UC platform. An example embodiment of a UC application module 28 for the server device 20 is depicted in FIG. 3. The UC application module 28 for the server device 20 includes software applications that facilitate hosting functions for various types of communications between computing devices via the social network platform, such as email messaging application(s) 40 (e.g., email, calendaring and scheduling, contact lists, etc.), instant messaging or SMS application(s) 42 that facilitate instant messaging, SMS text messaging and/or any other suitable types of real-time messaging between computing devices, A/V conferencing application(s) 44 that facilitate audio and/or video conferences between computing devices within the UC platform (including desktop sharing of content from one or more computing devices within a session), and application(s) 46 that manage content that is exchanged between computing devices over the platform (e.g., the sharing of documents or other types of content or information). The module 28 also includes one or more presence status management application(s) 43 to monitor, adjust and/or control the presence status of the computing device 2 within the UC platform based upon operations currently performed within the UC platform in relation to the computing device 2 (e.g., engaging in conference sessions, IM communications or any other types of communications within the UC platform) and/or manually designated status indications for the computing device 2 (e.g., a “do not disturb” status provided by a user of the computing device 2 within the UC platform). The presence status management application(s) 43 of the server device 20 can also provide user status information to the computing device 2 for use by the presence status management application(s) 33 stored at the computing device 2 so as to facilitate monitoring, adjustment and/or control of user presence status locally by the computing device 2 for controlling and managing software operations at the computing device 2 as described herein.

The module 28 also includes one or more user configuration table applications 48 that manage configuration tables for users within the UC platform according to the techniques as described herein. In particular, each user within the UC platform, including the user associated with computing device 2, includes a user configuration table that provides an indication of whether certain types of automated software operations are allowed to be initiated or activated in association with the computing device of the user (e.g., operated locally on the user's computing device or within the UC environment associated with the computing device) based upon a particular status of the user as identified locally and/or within the UC platform by presence status management application(s) 33 and 43. Automated software operations that can occur in association with the user's computing device 2 include any types of software operations that are not manually initiated by the user but instead automatically initiated based upon a predetermined condition associated with the computing device (e.g., activation of an antivirus scan of the computing device by one or more antivirus protection software applications, activation of a disk scan or backup of data associated with the computing device, etc.) or based upon conditions not controlled by the user while the user is operating within an environment such as the UC platform (e.g., an attempt to connect with the computing device 2 by another computing device to initiate a communication such as an instant message, an IP phone call or other type of real-time communication, or a system administrator initiates a software operation on the computing device (e.g., within a local area network (LAN), a wide area network (WAN) or any other suitable network in which the computing device is connected with a local server) or within the UC environment associated with the computing device, such as a software update).

While the example embodiments described herein depict the configuration table applications 48 residing at a UC server, it is noted that one or more applications which manage the configuration table for each user can also reside at the computing device for each user, such that configuration table information for each user can be managed and maintained solely by the computing device of each user, can be managed and maintained by one or more UC servers with which the user's computing device connects when within the UC platform, or can be managed and maintained by any combination of the user's computing device and one or more UC servers.

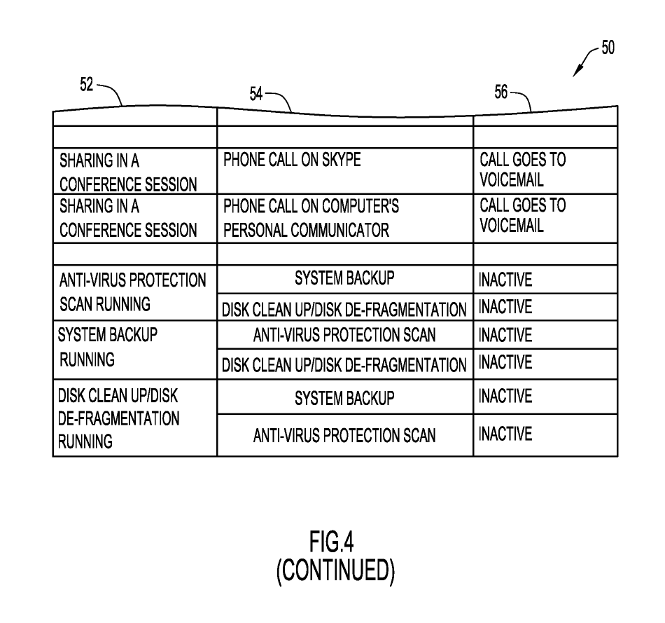

An example embodiment of a configuration table for the user of computing device 2 is depicted in FIG. 4. The user configuration table 50 includes a User Status/System Status column 52 that establishes a presence indication or status for the user as well as a system status (e.g., current status of software operations being performed on the user's computing device) while operating within the UC platform during a given time period. It is noted that the term “user status designation”, as used herein, refers to both presence status indications of a user (e.g., “available, “in meeting”, etc.) associated with a computing device as well as system status designations (e.g., some software operation currently running on computing device, such as an anti-virus scan, a system backup, etc.) Example status conditions are provided in column 52 of the table 50 and include a status of a user currently engaged or sharing in a conference session, a “do not disturb” status for the user (indicating the user is busy and not to be disturbed at the current time period), a user currently in a meeting, a presence status of the user being available within the UC platform, a presence status of the user being away (e.g., away from computing device) or idle within the UC platform (e.g., based upon no activity by the user over a designated time period including a current time period), and the status of the user being on a phone call (e.g., a VoIP communication). These examples are non-limiting, and any other types and number of status conditions can also be provided in a user configuration table.

A user status provided in column 52 of the configuration table 50 can also be set as a system status based upon some application that is currently operating at the computing device 2, such as an anti-virus protection scan that is running locally at the computing device 2, a system backup that is running and involves software operations at the computing device 2, a disk clean up/disk de-fragmentation that is occurring locally at the computing device, etc. It may be desirable to prevent automatic operation of one software operation that may consume large resources (e.g., disk clean up/disk de-fragmentation) at the computing device 2 while another software operation is currently in operation (e.g., an anti-virus scan or a system update, which is indicated by the user status designation) at or in relation to the computing device 2. The user status settings depicted at the end of the configuration table 50 for software operations currently running are non-limiting examples, and any other types of software operation user status settings for the computing device 2 with corresponding rules regarding with other automatic software operations can also be provided within the configuration table 50.

Such status conditions listed in the configuration table 50 can be manually set or adjusted by a user or a UC system administrator. For example, if a user wishes to customize his or her user configuration table, the user's interface 38 that allows the user to interact within the UC platform can allow the user to select from any suitable number of status configurations for implementing within the configuration table 50 of the user.

A user's current status designation can be manually set by the user (e.g., via the user interface 38 and the presence status management application(s) 33) or a UC system administrator (via the UC server 20 and/or utilizing the presence status management application(s) 43) and/or automatically set based upon the current conditions of the computing device 2 within the UC platform (e.g., if the user is engaged in an A/V conference session or in a phone call via the UC platform, the user status is automatically set to the appropriate indicator utilizing the presence status management application(s) 33 and/or presence status management application(s) 43). The current status of the user can be stored at the memory 8 of the user's computing device 2 and/or at the memory 24 of the UC server device 20 and monitored via at least one of the presence status management applications 33, 43. As conditions associated with the computing device 2 change during operation within the UC platform, the user's status can also be changed manually or automatically (e.g., utilizing the presence status management applications 33, 43). For example, if the user status is currently set at “do not disturb” (which was manually set by the user, e.g., the user may have been busy working on a project and did not want to be bothered or disturbed by any incoming communications or other disruptions), the user may decide to change this status to “available” (e.g., the user may wish to render the computing device 2 available for communications or other automated types of software operations). In another example, an automated change of the user status from being engaged/sharing in a conference session may change to “available” in response to the computing device 2 no longer being engaged in the conference session or no longer sharing content within the conference session.

The user configuration table provides rules for one or more types of applications that can perform automated software operations on the computing device 2 of the user based upon the user status designation currently set in relation to the computing device 2. In the example embodiment depicted in FIG. 4, the configuration table 50 includes an Application column 54 that lists different applications capable of performing automated software operations on the computing device 2. The automated software operations can be performed on the computing device 2 by applications located locally on the computing device 2 and/or located on the UC platform. Examples of different types of applications that perform automated software operations on the computing device 2, as listed in the configuration table 50 of FIG. 4, include: instant messaging (e.g., where the computing device receives instant messages initiated by other users); system backup (where a backup or copying and saving of data operation occurs on the computing device 2 that is associated with one or more applications that run locally on the computing device 2 and/or on the UC platform); an anti-virus protection scan (where one or more applications residing locally on the computing device 2 and/or on the UC platform perform automated software operations of conventional or any other suitable types on the computing device 2 associated with scanning/identification/quarantining, etc. in relation to virus applications that may reside on the computing device 2 or in the environment in which the computing device operates within the UC platform); a disk clean up/disk fragmentation operation (e.g., a system software operation that is automatically scheduled over select time periods or is implemented by a system administrator to optimize hardware storage space and operation of the computing device 2 utilizing conventional or any other suitable types of disk clean up/disk fragmentation applications); installation of a software upgrade for one or more applications residing locally on the computing device 2 or within the UC platform in which the computing device 2 operates (e.g., software upgrades can be automatically implemented when new software versions are available for applications associated with the computing device 2 and/or based upon an upgrade schedule controlled, e.g., by a system administrator); and voice over IP (VoIP) phone calls or other types of phone call communications automatically initiated at the computing device 2 by a user at an IP phone or other computing device (e.g., a Skype™ phone call, a phone call initiated by Cisco Personal Communicator or any other type of phone call). However, it is noted that any other types of applications capable of performing automated software applications associated with the computing device 2 can also be provided in the configuration table 50 and subject to control via the rules set forth in the configuration table as described herein.

A Rule column 56 is also provided in the user configuration table 50 that provides a rule of active or inactive for each user status associated with each application. The term “active” for a particular application and corresponding user status indication establishes the rule that the automated software operation to be performed by the application in relation to the computing device 2 is allowed when that user status indication is currently designated for the computing device 2, while the term “inactive” establishes the rule that the automated software application cannot be performed and/or must be delayed a designated time period when that user status indication is currently designated for the computing device 2.

Other rules can also be defined and applied within the configuration table 50, such as rules that specify a time period in which an application must remain inactive in relation to an automated software operation associated with the computing device 2. Another example rule (as shown in configuration table 50) is, when a user presence status is sharing in a conference session, any VoIP or other type of phone call to the computing device 2 results in an automated directing of the call to the user's voicemail associated with the computing device. Other rules can also be defined that more specifically define changing conditions within a user status designation that allow for a change or modification to the rule. For example, for an instant messaging application and a user status indicating the user is engaged in and sharing content within a conference session, a rule may be defined within the configuration table 50 that specifies that an instant messaging application cannot deliver an instant message to the computing device 2 while the user is designated as a presenter or is sharing content within an ongoing conference session, but that as soon as the user is no longer designated as the presenter or is no longer sharing content within the conference session an instant message is then allowed to be sent to the computing device 2 (even though the user may still be engaged within the conference session). The automated software operation, such as the sending of an instant message to a user of the computing device 2, can be delayed until the user status changes (e.g., the user's status changes from being a presenter or sharing content within an ongoing conference session to simply being engaged in an ongoing conference session, e.g., as a passive participant that is not currently presenting or not currently sharing content).

Rules that are associated with a user configuration table based upon a current user status designation can be implemented and maintained locally by the computing device 2 (e.g., by the operating system of the computing device 2) and/or by the UC server device 20 while the computing device is operating within the UC platform.

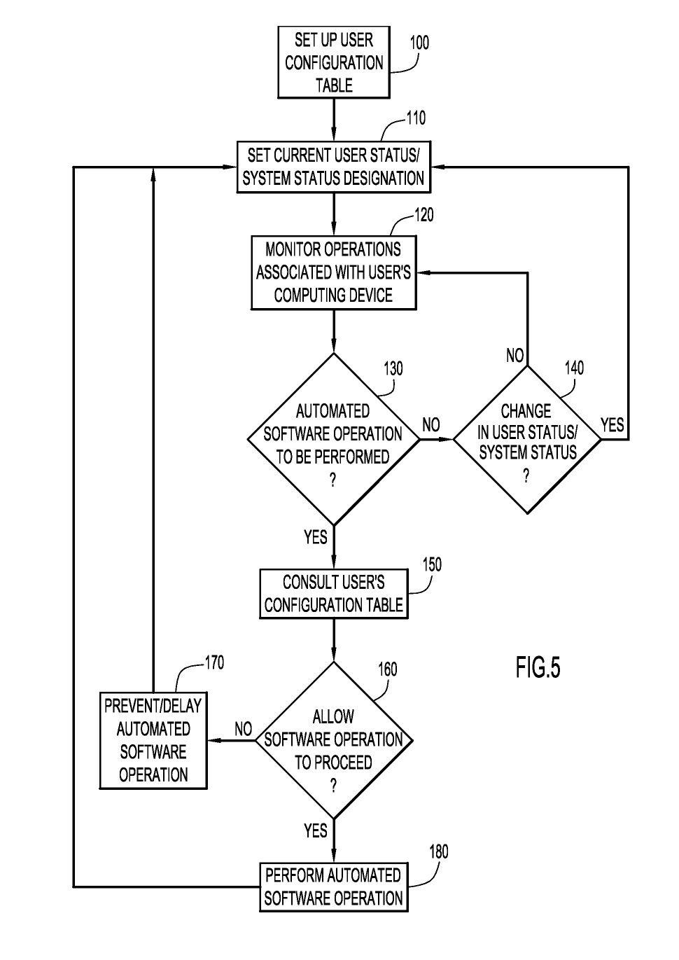

An example embodiment that implements the management of software operations in the system of FIGS. 1-3 and based upon the user's status and utilizing a user configuration table 50 is now described with reference to the flowchart of FIG. 5. At 100, a user configuration table, such as table 50, is set up for the computing device 2. As previously noted, the configuration table 50 and/or information associated with the configuration table 50 can be stored at one or both of the computing device 2 and the UC server device 20. User status indications, types of applications that perform automated software operations in association with the computing device 2 (e.g., automated software operations performed locally on the computing device 2 or in relation to the environment in which the computing device 2 operates within the UC platform, such as automated software operations associated with the user's account within the UC platform), and rules associated with the user status indications and applications can be set up within the user configuration table 50. In an example embodiment, certain default rule configurations can be initially designated for the user (e.g., based upon typical UC platform conditions for users), where the configuration table 50 can be modified as desired by the user (e.g., via the user interface 38) and/or by a UC system administrator. For example, a default configuration may only include certain applications or certain rules for applications or certain user status designations, with the option to add, delete or modify any of these thus allowing a user to customize or tailor the user configuration table for the user (e.g., based upon typical activities engaged in by the user within the UC platform).

At 110, a current user status designation (which includes user presence status and system status designations) for the computing device 2 in relation to the UC platform is selected. At any given time, a current status designation can be manually implemented by the user (e.g., using the user interface 38 and presence status application(s) 33, 43) or a system administrator or automatically implemented. For example, presence status application(s) 33 within the UC applications module 14 of the computing device 2 and/or the presence status application(s) 43 of the UC applications module 28 of the UC server device 20 can automatically control the current status designation of the user for the computing device 2 based upon operations currently occurring on the computing device 2, either locally or within the UC platform (e.g., the user engages in an activity within the UC platform, such as engaging in an A/V conference session, a VoIP call or type of communication session, etc.). Initially, the user status can be set to a default designation (e.g., the user status designation may be automatically set to available when the user initially logs into the computing device 2 or into the UC platform) or manually set by the user. The user status designation will change as the computing device engages in different operations within the UC platform and/or performs certain software operations locally.

At 120, operations on the user's computing device 2 are monitored by the computing device 2 and/or the UC server device 20. These operations include software operations currently being performed by the user as well as any software operations that are automatically being performed or are scheduled to be performed. At 130, a determination is made whether any automated software operation, which has not yet been initiated, is scheduled to be performed on the computing device 2 or within an environment within the UC platform that is associated with the computing device 2. For example, the computing device 2 and/or the UC server device 20 may determine that an incoming instant message is to be delivered to the user at the computing device 2 (which results in some automated software operation to be performed at or in relation to the computing device 2), or that an anti-virus protection scan is set to be performed or a software upgrade is set to be installed by one or more applications either locally on the computing device 2 or within the UC platform in relation to the operating environment in which the computing device 2 engages within the UC platform. If no automated software operation is scheduled to be performed at the moment, a determination is made at 140 whether there is a change in the user status (e.g., the user might engage in an A/V conference session or a VoIP phone call). In response to a change in user status being identified by the computing device 2 and/or the UC server device 20 (e.g., via the presence management applications 33, 43), the user status is set to the current user status designation at 110 and monitoring of operations on the user's computing device 2 is monitored at 120. It is noted that, while step 140 is shown subsequent to step 130 in the flowchart of FIG. 5, the identification of automated software operations to be performed and any change in user status at the computing device 2 can occur simultaneously with respect to each other during the process of managing automated software operations on the user's computing device 2 based upon the user status.

In response to a determination being made at 130 that an automated software operation is set or scheduled to be performed on the computing device 2, the user configuration table 50 is consulted at 150, by the computing device 2 and/or the UC server device 20, in order to determine whether a particular rule is to be invoked for the application that is set to perform the automated software operation. The rule can be active (i.e., allow automated software operation to proceed), inactive (i.e., do not allow automated software operation to proceed), or active or inactive with a condition (e.g., allow automated operation to proceed or not to proceed if or when a condition X is or is not present).

A determination is made at 160, by the computing device 2 and/or the UC server device 20, whether to allow the automated software operation to proceed in relation to the computing device 2 based upon whether the application is listed in the user configuration table 50, the current user status and also the particular rule to be invoked based upon the application and current user status. For example, in a scenario in which the application is an anti-virus protection application and the automated software operation to be performed is an anti-virus scan on the computing device 2, if the user's current status is engaged (or sharing) in an ongoing conference session, the rule according to the user configuration table 50 is that the application should be inactive (i.e., do not perform the automated software operation while this current status is designated). Alternatively, if the user's current status is available, the rule according to the user configuration table 50 is that the application should be active (i.e., allow performance of the automated software operation at this time based upon the current user status). In response to the rule providing an active status for the application, the application is allowed to perform the automated software operation in association with the user's computing device 2 at 180. The process of the flowchart of FIG. 5 is then repeated at 110 (i.e., setting of current user status designations, which include both user presence status and system status designations).

In response to the rule providing an inactive status for the application, the application is prevented or delayed from performing the automated software operation in relation to the computing device 2 at 170 while the current user status remains the same, and the process of the flowchart of FIG. 5 is then repeated at 110 (i.e., setting of current user status designations, which includes both user presence status and system status designations). As previously noted, in the event an operational condition in relation to the user's computing device 2 changes, this can change the user status resulting in a change of the rule associated with the application. For example, an instant message scheduled for delivery to the user's computing device 2 may be delayed while the user is engaged (or sharing) in an ongoing conference session. When this user status changes (e.g., the user terminates the conference session or is no longer sharing within the ongoing conference session), the rule may be changed to active thus allowing the delayed instant message to be sent to the user's computing device 2. Operations on the computing device 2 can continue to be monitored while the user is operating within the UC platform.

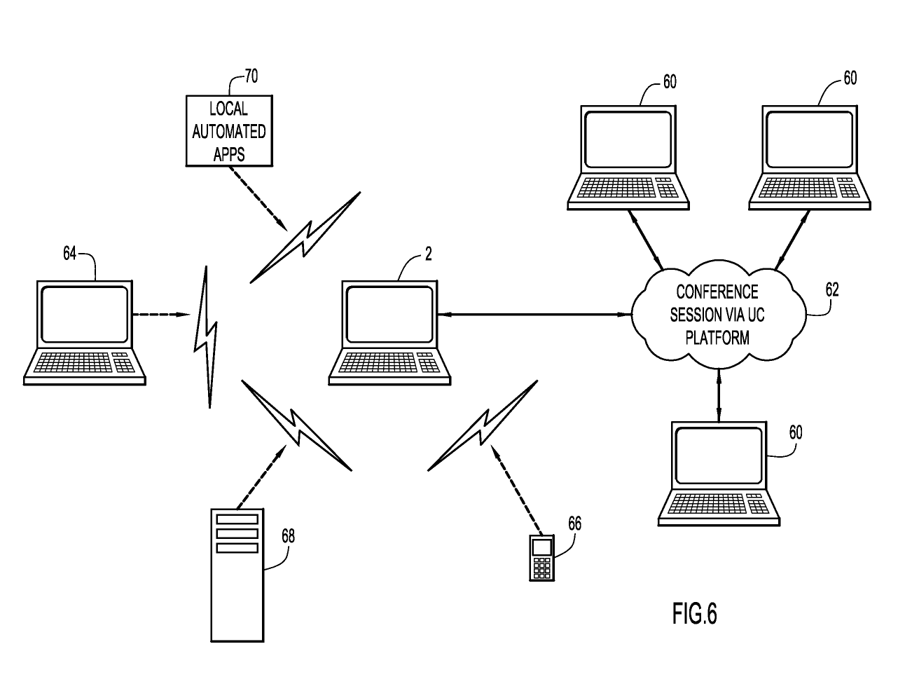

An example scenario is depicted in FIG. 6, in which a computing device 2 is engaged in a meeting conference session (e.g., a video conference) with other computing devices 60 via the UC platform 62. As previously noted, the computing device 2 depicted in FIG. 6, while shown as a desktop or portable computing device, can be any suitable type of computing device including, without limitation, a stationary (e.g., desktop) computer, a personal mobile computer device such as a laptop, a note pad, a tablet, a personal data assistant (PDA) device, any other suitable type of portable media player device, and a cell phone (e.g., a smartphone). In addition to being on a network (e.g., a wide area network or WAN) that supports the UC platform 62 for all of the computing devices 2, 60, the computing device can also be on any other networks, such as another WAN or a local area network (LAN). For example, the computing device 2 may be on a LAN within a company office supported by at least one local server. Alternatively, the computing device 2 can be connected via any suitable network (e.g., a WAN) with a server. The computing device 2 is shown in FIG. 6 as being connected (e.g., via a LAN or a WAN) with a server 68. During the time period in which the computing device 2 is engaged in the meeting conference session, the user status for the computing device 2 can be automatically adjusted (e.g., via presence status application(s) 33, 43) to the user status of “engaged or sharing in conference session” as depicted in the table 50 of FIG. 4. During this status, certain automated operations are not permitted on the computing device 2 based upon the rules associated with the user presence status. For example, attempts by an administrator at the server 68 to install a software upgrade would be prevented based upon the rule associated with this automated action being designated as “inactive”.

In addition, another computing device 64, which may also communicate with computing device 2 via a suitable network such as a LAN (e.g., the user of computing device 64 can be an employee at the same company location as the user of computing device 2) or over a WAN (e.g., via the UC platform 62 or via some other networking platform), attempts to engage in an IM session by sending an IM to the computing device 2. The rule for this automated software operation, as indicated by configuration table 50, is also “inactive”, such that the IM is prevented from being sent to the computing device 2 or is optionally delayed (e.g., the IM is sent after the computing device 2 is no longer engaged or sharing in the conference session). In this scenario, an automated reply 1M might be sent from the computing device 2 to the computing device 64 indicating that the user at computing device 2 is busy (e.g., “Currently engaged in meeting and unavailable, I will reply when meeting is over and I am available”).

In a further scenario, an automated software operation, such as an anti-virus scan, a system backup operation, or a disk cleanup/fragmentation operation, may be scheduled by one or more local automated software applications 70 at the computing device 2 while the computing device is engaged or sharing in the meeting session. The rules in configuration table 50 indicate “inactive” for these types of operations, such that these types of automated software operations would be prevented or delayed from executing until the user presence status is no longer engaged or sharing in the meeting session (e.g., these automated software operations could be delayed until after the meeting session is over).

A user with a smart phone or other computing device 66 might attempt a phone call with the user at the computing device 2 while the user is still engaged or sharing in the conference session. For example, the user at smart phone/computing device 66 might attempt a Skype™ session or a session utilizing Cisco Personal Communicator (or other types of VoIP communications) with the computing device 2. Referring to the configuration table 50 for computing device 2, such an attempt at communicating with the computing device 2 would result in an automatic connection with the user voicemail of the computing device 2 in the event the user presence status was “sharing in a conference session” as set forth in table 50. In this scenario, the user is engaged and may be a current speaker within the conference session and thus should not be disturbed by any incoming communication. The presence status applications 33, 43 can monitor this status, such that when the user is no longer sharing in the conference session (e.g., the user at computing device 2 is no longer the current speaker and is not currently sharing content for the conference session, but may still be engaged in the conference session), the user presence status may be changed to another status indication (e.g., “engaged in conference session”). Depending upon the rule associated with the changed status indication, a phone call or other automated communication attempt with the computing device 2 may then be allowed (e.g., the rule associated with this status indication may be “active”). Alternatively, the rule may be to not allow any phone call/communication attempts with the computing device 2 while the computing device 2 is engaged in any manner (i.e., whether sharing or not) within the conference session.

It is noted that the embodiments described herein and depicted in FIGS. 4 and 6 are for example purposes and in no way limit the systems and techniques to such embodiments. Any suitable types of presence status designations, applications and rules associated with such presence status designations and applications can be predefined and implemented within a user configuration table to facilitate control and management of automated software applications to be performed on a computing device based upon a current user presence status associated with the computing device.

Thus, the embodiments described herein efficiently manage operations for a user within a UC platform by managing automated software operations associated with the user's computing device based upon the user's status (e.g., presence status) within the UC platform. A variety of different types of applications that perform automated software operations can be controlled for a variety of different user status designations, and also with different rules being applied for different applications based upon the status designations associated with such applications as set forth in a user configuration table associated with a computing device. For example, when a user is engaged in a communication such as an A/V conference session or a phone call within the UC platform, the user may wish for certain applications to not perform software operations (or to conditionally be allowed to perform such software operations) associated with the user's computing device, and this is accomplished by providing suitable information within the user configuration table to address this scenario. Other types of management of automated software operations can also be easily controlled by setting appropriate rules within the user configuration table for the applications that perform such operations based upon user status designations associated with the computing device within the UC platform, where the user configuration table is consulted as needed when any of such applications are set to initiate an automated software operation associated with the computing device.

The above description is intended by way of example only.

What is claimed is:

1. A method comprising:
facilitating operation of a computing device, via a server, within a unified communications platform, wherein a user status designation is assigned to the computing device;
establishing a user configuration table for the computing device, wherein the user configuration table provides information relating to a plurality of user status designations associated with operation of the computing device within the unified communications platform;
in response to identifying, by at least one of the computing device and the server, an automated software operation scheduled to be performed at the computing device, consulting the user configuration table to determine a rule associated with the user status designation and the automated software operation; and
in response to a determination of the rule, applying the rule via at least one of the computing device and the server that controls performance of the automated software operation at the computing device.

2. The method of claim 1, wherein the user configuration table includes a plurality of user status designations, a plurality of corresponding applications configured to perform automated software operations at the computing device, and a plurality of corresponding rules, with each rule controlling operation of each application in association with the computing device based upon a user status designation that corresponds with the application.

3. The method of claim 1, wherein the rule comprises one of preventing performance of the automated software operation and delaying performance of the automated software operation.

4. The method of claim 3, further comprising:
changing the user status designation assigned to the computing device by at least one of the computing device and the server of the unified communications platform;
in response to identifying the change in user status designation, consulting the user configuration table to determine whether a rule corresponding with the changed user status designation permits performance of the automated software operation; and
in response to a determination that the rule corresponding with the changed user status designation permits performance of the automated software operation, enabling performance via at least one of the computing device and the server of the automated software operation at the computing device.

5. The method of claim 4, wherein the change in user status designation is assigned by at least one of the computing device and the server.

6. The method of claim 1, wherein the user status designation is manually assigned by a user at the computing device.

7. The method of claim 1, wherein the user status designation is automatically assigned via at least one of the computing device and the server based upon current operations performed by the computing device.

8. The method of claim 1, wherein the automated software operation comprises at least one of an attempt to engage in a communication session with the computing device by a second computing device, an automated software operation initiated locally at the computing device, and a software upgrade initiated remotely from the computing device for modifying software stored at the computing device.

9. An apparatus comprising:
a memory configured to store instructions including one or more applications that support communications between the apparatus and other computing devices via a server within a unified communications platform over a network;
a network interface device configured to enable communications over the network; and
a processor coupled to the network interface device and the memory, and configured to execute and control operations of the one or more applications so as to:
establish a user configuration table for the apparatus, wherein the user configuration table provides information relating to a plurality of user status designations associated with operation of the apparatus within the unified communications platform;
in response to identifying an automated software operation scheduled to be performed at the apparatus and a user status designation assigned to the apparatus, consulting the user configuration table to determine a rule associated with the user status designation and the automated software operation; and
in response to a determination of the rule, applying the rule that controls performance of the automated software operation at the apparatus.

10. The apparatus of claim 9, wherein the processor is further configured to assign the user status designation to the apparatus.

11. The apparatus of claim 9, wherein the processor is configured to establish the user configuration table comprising a plurality of user status designations, a plurality of corresponding applications configured to perform automated software operations at the apparatus, and a plurality of corresponding rules, with each rule controlling operation of each application in association with the apparatus based upon a user status designation that corresponds with the application.

12. The apparatus of claim 9, wherein the processor is configured to apply the rule by one of preventing performance of the automated software operation and delaying performance of the automated software operation.

13. The apparatus of claim 12, wherein the processor is further configured to:
change the user status designation assigned to the apparatus;
consult the user configuration table to determine whether the changed user status designation includes a corresponding rule that permits performance of the automated software operation; and
in response to a determination that the rule corresponding with the changed user status designation permits performance of the automated software operation, enable performance of the automated software operation at the apparatus.

14. The apparatus of claim 13, wherein the processor is configured to perform at least one of assigning the user status designation and changing the user status designation based upon a manual input by a user of the apparatus.

15. The apparatus of claim 13, wherein the processor is configured to perform at least one of assigning the user status designation and changing the user status designation automatically based upon current operations performed by the apparatus.

16. The apparatus of claim 9, wherein the processor is configured to identify an automated software operation comprising at least one of an attempt to engage in a communication session with the apparatus by a another computing device, an automated software operation initiated locally at the apparatus, and a software upgrade initiated remotely from the apparatus for modifying software stored at the apparatus.

17. One or more tangible computer readable storage media encoded with software comprising computer executable instructions and when the software is executed operable to:
facilitate operation of a computing device, via a server, within a unified communications platform, wherein a user status designation is assigned to the computing device;
establish a user configuration table for the computing device, wherein the user configuration table provides information relating to a plurality of user status designations associated with operation of the computing device within the unified communications platform;
in response to identifying, by at least one of the computing device and the server, an automated software operation scheduled to be performed at the computing device, consulting the user configuration table to determine a rule associated with the user status designation and the automated software operation; and
in response to a determination of the rule, applying the rule via at least one of the computing device and the server that controls performance of the automated software operation at the computing device.

18. The computer readable storage media of claim 17, wherein the instructions are operable to establish the user configuration table comprising a plurality of user status designations, a plurality of corresponding applications configured to perform automated software operations at the computing device, and a plurality of corresponding rules, with each rule controlling operation of each application in association with the computing device based upon a user status designation that corresponds with the application.

19. The computer readable storage media of claim 17, wherein the instructions are operable to determine that the rule comprises one of preventing performance of the automated software operation and delaying performance of the automated software operation.

20. The computer readable storage media of claim 19, wherein the instructions are operable to:
change the user status designation assigned to the computing device by at least one of the computing device and the server of the unified communications platform;
in response to identifying the change in user status designation, consult the user configuration table to determine whether a rule corresponding with the changed user status designation permits performance of the automated software operation; and
in response to a determination that the rule corresponding with the changed user status designation permits performance of the automated software operation, enable performance via at least one of the computing device and the server of the automated software operation at the computing device.

21. The computer readable storage media of claim 17, wherein the instructions are operable to facilitate manual assignment of the user status designation by a user at the computing device.

22. The computer readable storage media of claim 17, wherein the instructions are operable to facilitate automatic assignment, via at least one of the computing device and the server, of the user status designation based upon current operations performed by the computing device.

23. The computer readable storage media of claim 17, wherein the instructions are operable to identify an automated software operation comprising at least one of an attempt to engage in a communication session with the computing device by a second computing device, an automated software operation initiated locally at the computing device, and a software upgrade initiated remotely from the computing device for modifying software stored at the computing device.
